(19) United States
(12) Patent Application Publication
(10) Pub. No.: US 2003/0102294 A1
(43) Pub. Date: Jun. 5, 2003

(54) Laser machining apparatus

(76) Inventors: Yoshihide Kinbara, Tokyo (JP); Kazuo Sakurai, Tokyo (JP); Yoshihiro Ikai, Tokyo (JP); Takaaki Mori, Tokyo (JP)

Correspondence Address: SUGHRUE MION, PLLC, 2100 PENNSYLVANIA AVENUE, N.W., WASHINGTON, DC, 20037, US

(21) Appl. No.: 10/258,353

(22) PCT Filed: May 23, 2001
(86) PCT No.: PCT/JP01/04321

(51) Int. Cl. B23K 26/04

(52) U.S. Cl. 219/121.83; 219/121.84

(57) ABSTRACT

An electrode for adsorption (17) is provided in the vicinity of the laser processing position, and an electrode (18) for detecting capacitance is provided on the outer periphery of the electrode for adsorption (17), so that the capacitance (C) between the electrode (18) for detecting capacitance and the workpiece (15) is detected, with a voltage being applied to between the electrode for adsorption (17) and the workpiece (15), to thereby control the focal position (12a) of the laser beam (12) based on the detected capacitance (C).

### TECHNICAL FIELD

This invention relates to a laser processing apparatus for welding, cutting a workpiece using lasers.

### BACKGROUND ART

In a conventional laser processing apparatus, a capacitance between a processing nozzle which emits laser beams and the workpiece is detected and focal distance of a laser beam is controlled based on the detected capacitance. That is, the capacitance changes depending on a change of position of the processing nozzle with respect to the workpiece. Hence, by controlling the position of the processing nozzle so that the capacitance becomes constant, the focal distance of the laser beam is always maintained at an optimum position.

In actual laser processing, however, for example, as described in “Influence of Shield Gas Plasma on Monitoring Signals in Laser Welding”, Welding Society Papers, Vol. 16, No. 2, pp. 169-180, 1998, when the laser beam is irradiated to a metallic workpiece, metal vapor is ionized to generate plasma between the workpiece and the processing nozzle. As a result, the plasma causes a large influence to the capacitance between the workpiece and the processing nozzle. That is, as shown in FIG. 13, plasma 3 between the processing nozzle 1 and the workpiece 2 has a size as small as 1 mm at a portion where it is generated, but after having been generated in the vicinity of the focal position of the laser beam 4, the plasma 3 drifts because of the machining gas, and fills the space between the processing nozzle 1 and the workpiece 2 so as to conducts electricity between these. Therefore, for example, even if the distance between the workpiece 2 and the processing nozzle 1 is kept constant, the capacitance C changes according to the volume of the generated plasma 3. As a result, it becomes difficult to maintain the focal distance of the laser beam 4 to the optimum position, and there is the possibility that the machining quality by the laser beam is largely affected.

Therefore, for example, in the laser processing apparatus disclosed in Japanese Patent Application Laid-Open No. 4-356391, as shown in FIG. 14, the generation of plasma 3 between the processing nozzle 1 and the workpiece 2 is suppressed by applying a direct current high voltage to between the processing nozzle 1 and the workpiece 2.

Even in this conventional art, however, if the laser output is increased or the machining speed is increased, the suppression effect of the plasma generation decreases. Further, there is no change in the construction in which the processing nozzle 1 is an electrode for detecting the capacitance C. After all, even in the conventional art shown in FIG. 14, it is difficult to completely prevent the situation that the capacitance C changes due to the generation of plasma 3, in other words, to accurately control the position of the processing nozzle 1 with respect to the workpiece 2, and hence the machining quality cannot be improved. Particularly, when cutting of the workpiece is performed, the amount of plasma generation increases. Accordingly, there is also a problem in that it is difficult to increase the speed of laser machining.

Therefore, it is an object of the present invention to provide a laser processing apparatus which can perform laser processing with excellent processing quality.

### DISCLOSURE OF THE INVENTION

To achieve the above object, according to this invention, the laser processing apparatus comprises an electrode for adsorption provided in the vicinity of the laser processing position and an electrode for detecting capacitance provided on the outer peripheral portion of the electrode for adsorption. A voltage is applied to the electrode for adsorption and the workpiece and capacitance between the two is detected. The focal position of the laser beam is then controlled based on the detected capacitance.

According to this invention, the plasma generated due to the irradiation of the laser beam is adsorbed by the electrode for adsorption and the workpiece, thereby the situation that the plasma fills the space between the electrode for detecting capacitance and the workpiece can be effectively prevented.

According to the next invention, there is provided a laser processing apparatus, in the above invention, wherein a processing nozzle which emits the laser beam is formed of a conductor, and the end of this processing nozzle functions as the electrode for adsorption.

According to this invention, the processing nozzle functions as the electrode for adsorption.

According to the next invention, there is provided a laser processing apparatus, in the above invention, wherein the portion of the electrode for adsorption which faces the workpiece is formed flat, and the outer diameter of this flat portion is set such that at least 5 mm is ensured from the center thereof.

According to this invention, sufficient distance can be ensured between the laser processing position and the electrode for detecting capacitance.

According to the next invention, there is provided a laser processing apparatus which performs laser processing with respect to a workpiece, by irradiating a laser beam to the workpiece, wherein the quantity of plasma generated due to the laser processing is detected, and based on the detected plasma quantity, the laser processing conditions are controlled.

According to this invention, the laser processing conditions can be controlled depending on the quantity of plasma generated by the laser processing.

According to the next invention, there is provided a laser processing apparatus, further comprising, an electrode for detecting current provided at the end of the processing nozzle which emits the laser beam, and a detection unit which detects a current value flowing between the electrode for detecting current and the workpiece as the plasma quantity.

According to this invention, the current value flowing between the electrode for detecting current and the workpiece is detected as the plasma quantity.

According to the next invention, there is provided a laser processing apparatus, in the above invention, further comprising a malfunction detection signal output unit which outputs a processing malfunction detection signal, when the current value exceeds a first threshold set in advance.

According to this invention, when the current value exceeds the first threshold, the processing malfunction detection signal is output.

According to the next invention, there is provided a laser processing apparatus, in the above invention, wherein when the processing malfunction detection signal is output from the malfunction detection signal output unit, the processing speed is decreased and/or the laser output is increased.

According to this invention, when the processing malfunction detection signal is output from the malfunction detection signal output unit, the processing speed is decreased and/or the laser output is increased.

According to the next invention, there is provided a laser processing apparatus, in the above invention, further comprising a contact detection signal output unit which outputs a contact detection signal indicating that the processing nozzle has touched the workpiece, when the current value reaches a current value at the time when the processing nozzle and the workpiece are short-circuited.

According to this invention, when the processing nozzle touches the workpiece, the contact detection signal is output.

According to the next invention, there is provided a laser processing apparatus, in the above invention, wherein the processing speed and/or the laser output is controlled so that the current value falls below an upper tolerance set in advance.

According to this invention, processing speed and/or the laser output is controlled so that the value of the current flowing between the electrode for detecting the current and the workpiece always falls below the upper tolerance, in other words, so that the generation of plasma falls below the upper tolerance.

According to the next invention, there is provided a laser processing apparatus, in the above invention, wherein the position of the processing nozzle is controlled with respect to the workpiece, so that the current value becomes minimum.

According to this invention, the position of the processing nozzle is controlled with respect to the workpiece, so that the current value becomes minimum, that is, the plasma quantity becomes minimum.

### BRIEF DESCRIPTION OF THE DRAWINGS

FIG. 1 is a diagram which shows the construction of a laser processing apparatus, being one embodiment of the present invention,

FIG. 2 is a diagram which shows the relation between the plasma current flowing to a resistor and the processing speed, when a thin steel sheet is cut by laser processing, based on the test results,

FIG. 3 is a conceptual diagram of a main part, which explains the operation of the laser processing apparatus shown in FIG. 1,

FIG. 4 is a diagram which shows the relation between the plasma current and the capacitance sensor, when a laser beam is output from the laser processing apparatus shown in FIG. 1,

FIG. 5 is a block diagram which exemplifies a detailed construction of a processing control section shown in FIG. 1,

FIG. 6 is a diagram which shows the relation between the height of the processing head and the plasma current signal,

FIG. 7 and

FIG. 8 are diagrams which show the relation between the processing speed and the plasma current signal and the processing malfunction detection signal, respectively,

FIG. 9 is a diagram which shows the relation between the height of the processing head and the plasma current signal,

FIG. 10 is a diagram which shows the relation between the laser output, the plasma current signal and the processing speed,

FIG. 11 is a sectional view which shows the end portion of the processing head actually designed,

FIG. 12 is a conceptual diagram which shows another example of the processing head actually designed,

FIG. 13 is a conceptual diagram of a main part, which shows the operation of a conventional laser processing apparatus, and

FIG. 14 is a block diagram which explains a conventional laser processing apparatus.

### BEST MODE FOR CARRYING OUT THE INVENTION

Embodiment(s) of the laser processing apparatus according to the present invention will now be explained in detail, with reference to the accompanying drawings.

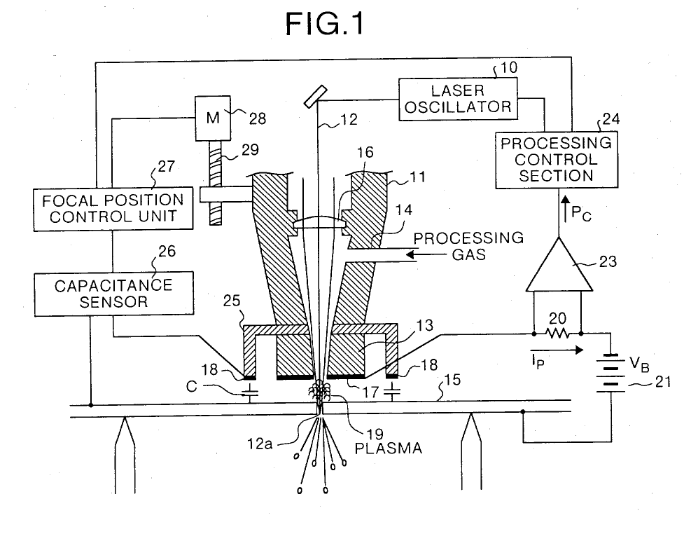

FIG. 1 is a diagram which shows the construction of a laser processing apparatus as one embodiment of the present invention. In this laser processing apparatus, a laser beam 12 guided from a laser oscillator 10 to a processing head 11 is emitted from a processing nozzle 13, and processing gas such as oxygen or air is supplied to the same axis as that of the laser beam 12 through a processing gas supply passage 14. The laser beam is used to perform laser processing such as cutting and welding with respect to a workpiece 15 such as iron plate. In this laser processing apparatus, there is provided a lens 16 for collecting the laser beam 12 to the processing head 11 at a focal position 12a, and when the focal position 12a of the laser beam 12 collected by the lens 16 is reconciled with the workpiece 15, the laser processing can be performed favorably.

The processing head 11 is provided with an electrode for adsorption 17 at the end of the processing nozzle 13, and an electrode 18 for detecting capacitance at the outer peripheral portion of the electrode for adsorption 17.

The electrode for adsorption 17 is formed such that the portion facing the workpiece 15 becomes flat. The diameter of this electrode for adsorption 17 is set so as to have a sufficiently large area compared to the size of the generated plasma 19. Specifically, since the diameter of the plasma 19 is about 1 mm, the diameter of the electrode for adsorption 17 is set to about 10 mm. The electrode for adsorption 17 may be formed by providing a special-purpose conductor at the end region of the processing nozzle 13. However, when the processing nozzle 13 is insulated, the processing nozzle can be formed of a conductor, so that the end face thereof functions as the electrode for adsorption 17.

To this electrode for adsorption 17, a resistor 20 and a DC power supply 21 are connected in series between the electrode for adsorption 17 and the workpiece 15. In FIG. 1, the negative electrode of the DC power supply 21 is connected to the electrode for adsorption 17, but the electrode for adsorption 17 may be connected to the positive electrode of the DC power supply 21. In the circuit connecting the workpiece 15 and the electrode for adsorption 17, there is provided a detection unit 22 which detects the current flowing to the resistor 20 (hereinafter, referred to as plasma current Ip). Specifically, the voltage of the resistor 20 is amplified by an amplifier 23, to detect this amplified voltage as a plasma current signal Pc.

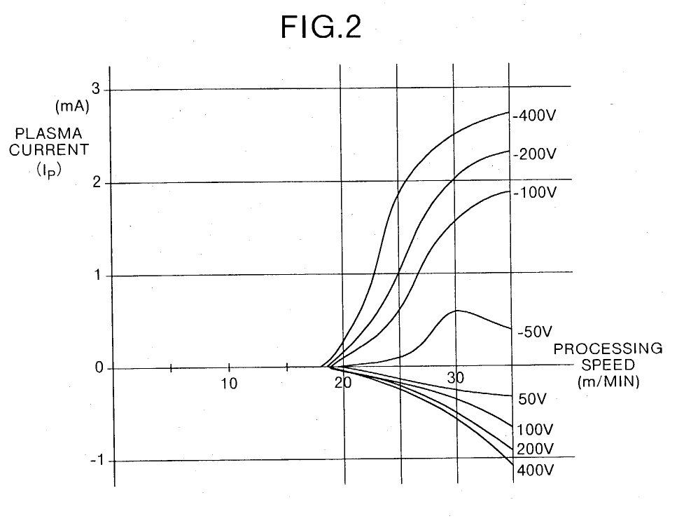

The graph of FIG. 2 shows the relation between the plasma current Ip flowing to the resistor 20 and the processing speed, when a thin steel sheet is cut by laser processing, based on the test results. The laser output was kept constant at 3 Kw. According to this result, it is seen that when the voltage applied to the electrode for adsorption 17 is set to at least 100V, the plasma current Ip can be detected favorably at a high speed. It is also seen that when the voltage is applied so that the electrode for adsorption 17 becomes the negative side, the value of the plasma current Ip is high. It is a matter of course that even when the voltage is applied so that the electrode for adsorption 17 becomes the positive side, the plasma current Ip flows similarly, and hence, if the sensitivity of the amplifier 23 is appropriately adjusted, measurement is possible.

The plasma current signal Pc detected by the detection unit 22 is provided to a processing control section 24. The processing control section 24 is for controlling the laser processing conditions such as the processing speed, the laser output, the focal position 12a of the laser beam 12 and the pressure of the processing gas, based on the plasma current signal Pc provided from the detection unit 22. The amplifier 23 of the detection unit 22 may amplify the partial pressure of the voltage of the resistor 20. As the resistor 20, one having a sufficiently high resistance is used so that even if the processing nozzle 13 touches the workpiece 15, the workpiece 15 is not burnt due to the voltage VB of the DC power supply 21.

On the other hand, the electrode 18 for detecting capacitance is fitted to the end portion of a support member 25 formed of an insulating material, and fixed at a position which is on the outer peripheral portion of the electrode for adsorption 17, via the support member 25. This electrode 18 for detecting capacitance is provided with a capacitance sensor 26 between the workpiece 15 and itself. The capacitance sensor 26 detects the capacitance C between the electrode 18 for detecting capacitance and the workpiece 15, and gives the detection result to a focal position control unit 27. The focal position control unit 27 is a section which performs position control of the processing head 11 with respect to the workpiece 15, according to the detection result given from the capacitance sensor 26.

In the laser processing apparatus constructed as described above, while laser processing such as cutting and welding is performed, by irradiating the laser beam 12 to the workpiece 15, the focal position control unit 27 drives a motor 28 based on the detection result of the capacitance sensor 26, to appropriately move the processing head 11 up and down via a screw 29. As a result, control is performed so that the capacitance C between the electrode 18 for detecting capacitance and the workpiece 15 becomes constant.

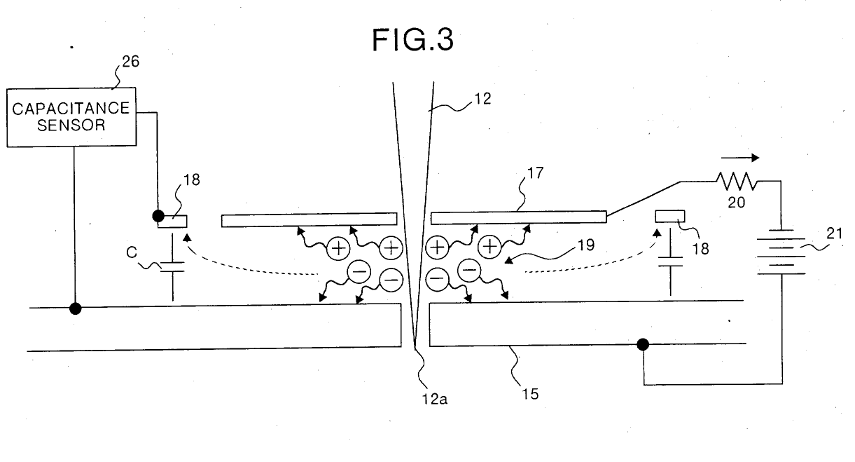

Even in this laser processing apparatus, when the laser output is high and processing is performed at a high speed, plasma 19 is generated between the workpiece 15 and the processing nozzle 13. This plasma 19 is made to flow at a high speed so as to expand from the focal position 12a outwards between the workpiece 15 and the processing nozzle 13, due to the action of the processing gas supplied together with the laser beam 12. In this laser processing apparatus, however, since a voltage by the DC power supply 21 is applied between the workpiece 15 and the electrode for adsorption 17, as shown in FIG. 3, positive ions of the metal vapor, of the ionized plasma 19, are attracted to the electrode for adsorption 17, and on the other hand, negative ions of electrons are attracted to the workpiece 15. Further, since the size of the electrode for adsorption 17 is set so as to have a sufficiently large area compared to the size of the generated plasma 19, not only the above-described adsorption becomes effective over a wide range, but also ions that are not adsorbed by the electrode for adsorption 17 and the workpiece 15 bond to each other to thereby die out spontaneously. Hence, there is no possibility of causing a situation that the plasma 19 fills the space between the electrode 18 for detecting capacitance and the workpiece 15. As a result, according to the laser processing apparatus in which the position control of the processing head 11 is performed based on the capacitance C between the electrode 18 for detecting capacitance and the workpiece 15, the capacitance C between these does not change even if the plasma 19 is generated, and the capacitance C changes only depending on the position of the processing head 11 with respect to the workpiece 15. Therefore, the focal position 12a of the laser beam 12 can be accurately maintained at an optimum position at all times, and even if the laser processing is performed at a high speed, the processing quality is improved.

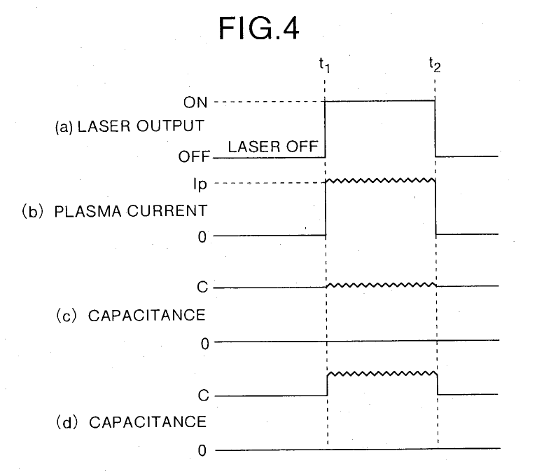

The time chart in FIG. 4 shows the relation between the plasma current Ip and the capacitance sensor 26, when the laser beam 12 is output from the laser processing apparatus. In FIG. 4, (a) depicts that the laser beam 12 is turned ON between times t1 and t2 and (b) depicts that the plasma current Ip flows with the laser beam 12 being in the ON state.

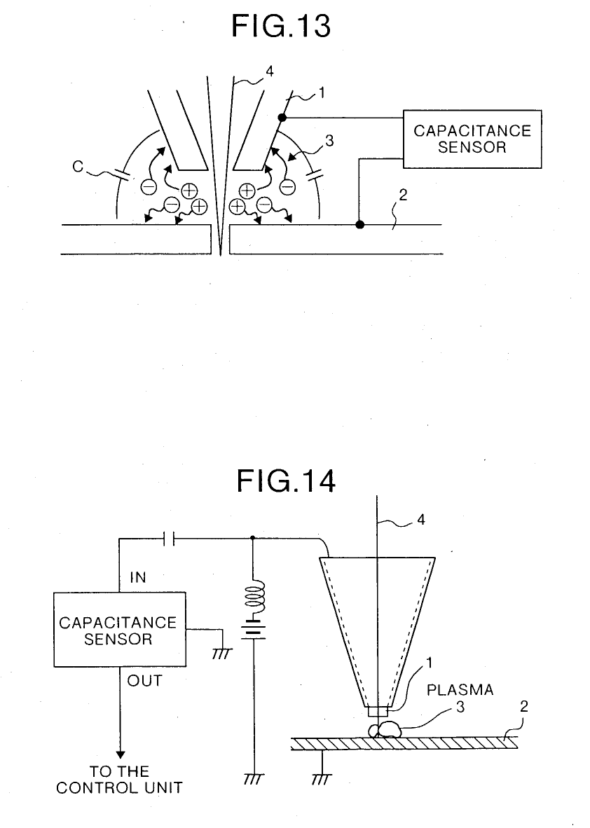

In FIG. 4, (d) shows the case of the conventional laser processing apparatus shown in FIG. 13. In this conventional laser processing apparatus, after the laser beam 12 has been turned ON, the generated plasma 19 allows electric conduction between the processing nozzle 13 and the workpiece 15. As a result, a change occurs in the capacitance C depending on the plasma current Ip.

On the other hand, according to the laser processing apparatus in this embodiment, the plasma 19 is adsorbed by the electrode for adsorption 17 and the workpiece 15, and hence the plasma 19 does not reach the space between the electrode 18 for detecting capacitance and the workpiece 15. As a result, as shown in (c), the capacitance C does not change according to the plasma current Ip. That is, by providing the electrode for adsorption 17 having a sufficient size for attracting the plasma 19 and applying a voltage between the electrode for adsorption 17 and the workpiece 15, the plasma 19 can be effectively adsorbed to thereby prevent the situation that the plasma 19 fills the space between the electrode 18 for detecting capacitance and the workpiece 15, and hence it becomes possible to accurately measure the capacitance C between these. The portion where the plasma 19 is generated is as small as about 1 mm, on the other hand, the diameter of the electrode for adsorption 17 is set such that at least 5 mm is ensured from the center thereof. Therefore, between the electrode for adsorption 17 and the workpiece 15, the plasma 19 is reliably adsorbed, thereby influence of the plasma 19 on between the electrode 18 for detecting capacitance and the workpiece 15 can be prevented.

On the other hand, in the laser processing apparatus, while laser processing such as cutting and welding is performed by irradiating the laser beam 12 to the workpiece 15, the processing control section 24 controls the laser processing conditions such as the processing speed, the laser output, the focal position 12a of the laser beam 12 and the pressure of the processing gas, based on the plasma current signal Pc detected by the detection unit 22. In this laser processing apparatus, when the plasma 19 generated by the laser processing is adsorbed by the electrode for adsorption 17 and the workpiece 15, the plasma current Ip flows to the series body formed of the resistor 20 and the DC power supply 21. If the plasma current Ip flows to the resistor 20, a voltage is generated in the resistor 20, and amplified by the amplifier 23 and detected as the plasma current signal Pc. The plasma current signal Pc is a signal which changes depending on the plasma quantity, as shown in FIG. 2. When the series body formed of this resistor 20 and the DC power supply 21 is connected to between the electrode for adsorption 17 and the workpiece 15, as described above, the plasma 19 can be effectively adsorbed, and the plasma current Ip can be detected as the plasma current signal Pc.

FIG. 5 is a block diagram which exemplifies a detailed construction of the processing control section 24 described above. As is clearly seen in the figure, the processing control section 24 is provided with two comparators 30 and 31, which compare the plasma current signal Pc provided from the detection unit 22 and comparison voltages 30a and 31a, respectively, and output a detection signal, when the plasma current signal Pc exceeds the comparison voltage.

The first comparator 30 provided in the processing control section 24 is for outputting a contact detection signal to a laser controller 32, when the electrode for adsorption 17 touches the workpiece 15. The laser controller 32, to which the contact detection signal has been provided, performs control required when the electrode for adsorption 17 touches the workpiece 15. Since the current flowing when the electrode for adsorption 17 touches the workpiece 15 is much higher than the plasma current Ip, a sufficiently high voltage can be set as the comparison voltage 30a. Therefore the detection of contact between the electrode for adsorption 17 and the workpiece 15 can be clearly performed. This contact detection can be used as one of important detection functions, such as when the height of the processing head 11 from the workpiece 15 is modified, or detection of contact of the processing nozzle 13 with the workpiece 15 due to abnormal state during processing. For example, at the point of time when the contact detection signal is output, by setting the relative height of the processing head 11 with respect to the workpiece 15 to “0”, the position control of the processing head 11 can be accurately performed.

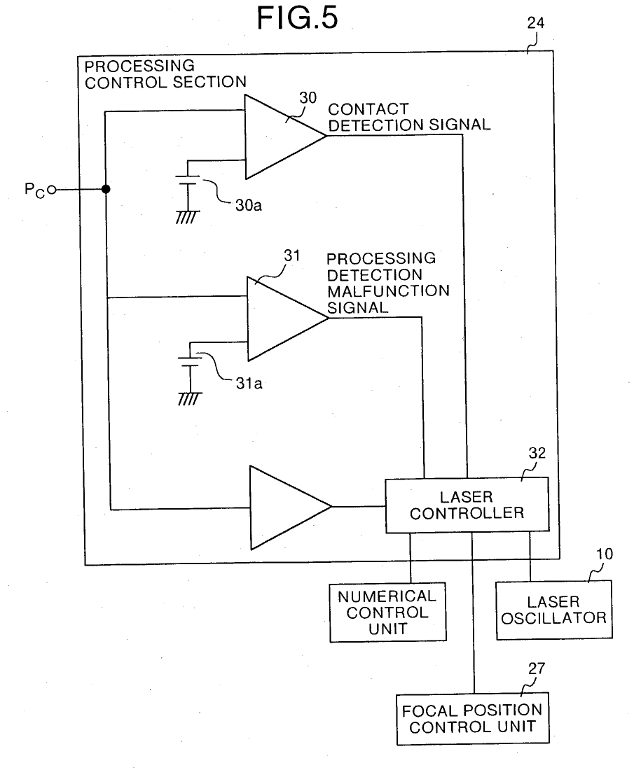

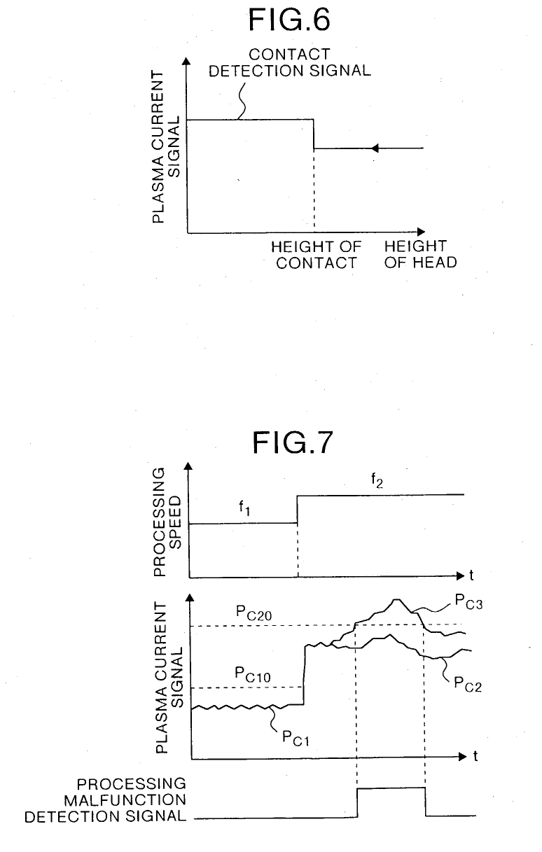

The graph in FIG. 6 shows the relation between the plasma current signal Pc and the height of the processing head 11. As is clear from this figure, as the height of the processing head 11 is decreased, when the electrode for adsorption 17 touches the workpiece 15, the plasma current signal Pc becomes considerably high (dotted line) compared to that of the non-contact state. The plasma current signal Pc at this event is output as the contact detection signal. As a result, it becomes possible for the laser controller 32 to detect the contact of the electrode for adsorption 17 and the workpiece 15.

The second comparator 31 provided in the processing control section 24 is for outputting a processing malfunction detection signal to the laser controller 32, when malfunction occurs in the processing state.

FIG. 7 explains when is the processing malfunction detection signal output. When the processing speed is increased from f1 to f2, a larger amount the plasma 19 is generated. As a result, the plasma current signal Pc increases from Pc1 to Pc2. In this case, if there is a malfunction in the processing state, since the amount of generation of the plasma 19 increases further, the plasma current signal Pc increases much more than the normal state, as shown by Pc3.

If it is assumed that the comparison voltage at the time of low processing speed fl and the comparison voltage at the time of high processing speed f2 are respectively set to Pc10 and Pc20 beforehand, the plasma current signal Pc1 output at the time of low processing speed fl falls below this comparison voltage Pc10, and hence the processing malfunction detection signal is not output. Also at the time of high processing speed f2, if the plasma current signal is Pc2, the processing malfunction detection signal is not output. However, if a malfunction occurs in the processing state, and the plasma current signal becomes Pc3, the processing malfunction detection signal is output to the laser controller 32 in the range exceeding the comparison voltage Pc20.

The laser controller 32, to which the processing malfunction detection signal has been provided from the second comparator 31, performs changes of various laser processing conditions, in order to restore the normal processing state. For example, the processing speed is reduced, the laser output is increased, the focal position 12a is changed, the processing gas pressure is changed, or the like. However, even if these laser processing conditions are changed, if the abnormal state continues, it is possible to stop or suspend the laser processing. The judgment of a change in these laser processing conditions or stop or suspension of laser processing is automatically performed by a program stored in advance in the laser controller 32.

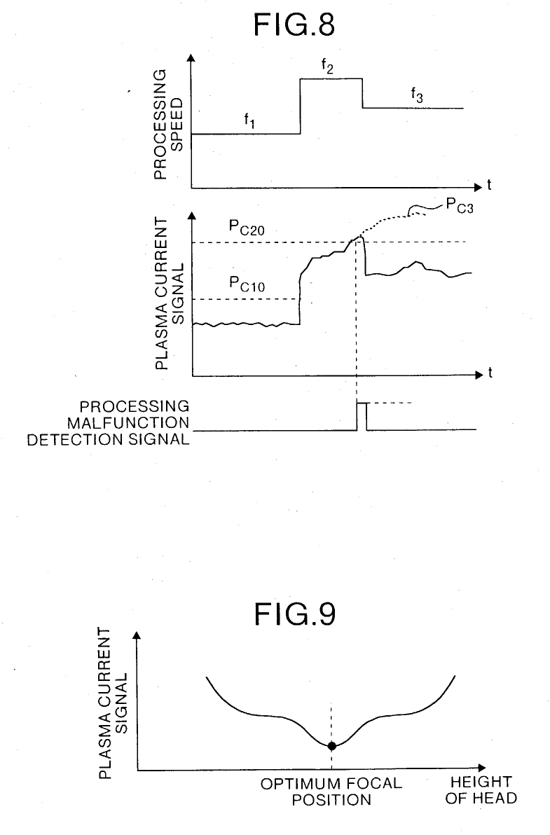

FIG. 8 shows the operation example of the laser controller 32. That is, it shows a situation in which after the processing speed has been changed from the low processing speed fl to the high processing speed f2, when the processing malfunction detection signal is output, the processing speed is reduced to f3 by the laser controller 32. Accompanying this, the plasma current signal Pc falls below the comparison voltage Pc20, and the normal processing state is restored. In FIG. 8, Pc3 shows such a state that when the processing speed is maintained at f2, the processing state remains abnormal, and the plasma current signal Pc increases. In this state, the processing malfunction detection signal will be output continuously to the laser controller 32.

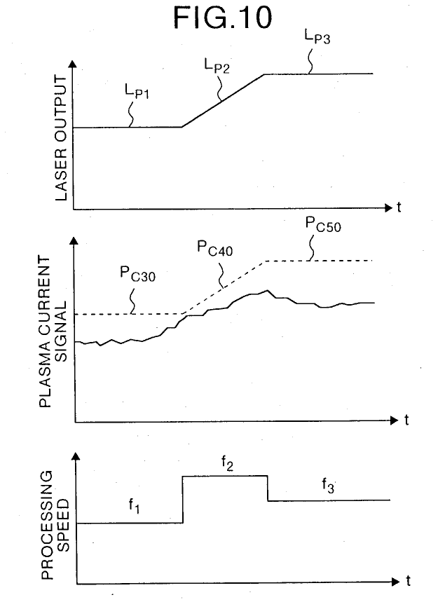

FIG. 9 and FIG. 10 show control examples of laser processing conditions executed by the laser controller 32 based on the plasma current signal Pc output from the detection unit 22, not relying on the detection signals from the two comparators 30 and 31 described above.

As shown in FIG. 9, the height of the processing head 11 is appropriately changed, to carry out the laser processing by designating the height of the processing head 11 at the time when the plasma current signal Pc becomes a minimum value as an optimum focal position. This optimum focal position changes delicately, depending on the height of the workpiece 15, the degree of the curve, and the state of the processing lens 16. Heretofore, people repeat try and error, to set the above-described optimum focal position. However, since it is difficult to set the optimum focal position during the laser processing, in the current state, such a method is being used in which boring is executed uncontinuously in the stopped state, and adjustment is performed by visual observation.

On the other hand, according to the laser processing apparatus, if the height of the processing head 11 is controlled so that the plasma current signal Pc always takes the minimum value, this height becomes the optimum focal position. Therefore, it is possible to accurately set this height even during the laser processing, and hence the processing quality can be improved considerably.

On the other hand, as shown in FIG. 10, when the processing speed is increased from f1 to f2, the plasma current signal Pc increases with respect to the comparison voltage Pc30. Hence, the laser output is gradually increased from Lp1 to Lp2, so that the comparison voltage Pc40 is also increased gradually corresponding thereto. When the laser output becomes a maximum value, and laser processing is executed at Lp3, automatic control is performed so that the processing speed is reduced to f3, in order to prevent the plasma current signal Pc from increasing further, to thereby maintain the stable processing state.

As described above, according to the laser processing apparatus, the processing control section 24 judges the processing state based on the plasma current signal Pc detected by the detection unit 22, and appropriately controls the laser processing conditions, thereby enabling execution of the proper laser processing.

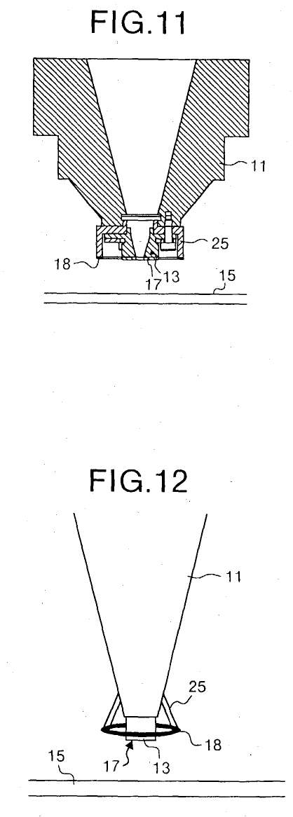

FIG. 11 shows a cross section of the end portion of the processing head 11. The electrode 18 for detecting capacitance C is provided at the end of a support member 25 formed of an insulating material. The processing nozzle 13 formed of an electrically conducting material such as copper is fixed to the processing head 11 together with the support member 25. Since the processing nozzle 13 is electrically conductive, the end portion thereof functions as the electrode for adsorption 17. The reason why the end of the processing nozzle 13 slightly protrudes than the electrode 18 for detecting capacitance is to prevent a damage of the electrode 18 for detecting capacitance, when it touches the workpiece 15. In the processing head 11 constituted as described above, if a predetermined voltage is applied to between the processing nozzle 13 and the workpiece 15, the laser processing apparatus shown in FIG. 1 can be realized. That is, even if the plasma 19 is generated, the capacitance C between the electrode 18 for detecting capacitance and the workpiece 15 can be accurately detected. As a result, the focal position 12a of the laser beam 12 can be controlled based on the detected capacitance C, to perform laser processing with excellent processing quality. Further, if the laser processing conditions are controlled depending on the plasma current Ip flowing between the electrode for adsorption 17 and the workpiece 15, laser processing with excellent processing quality becomes possible.

According to the laser processing apparatus in this embodiment, even if the plasma 19 is generated, the capacitance C can be accurately detected without being affected by the plasma 19, and the focal distance 12a can be controlled accurately based on this. On the contrary, by positively using the generated plasma 19 for the control of the processing conditions, a malfunction in the processing state can be detected and automatically controlled, within a short period of time, during which the human cannot judge and act.

Accordingly, high-speed laser processing at a high laser output, which cannot be realized heretofore due to the occurrence of plasma 19, more specifically, laser processing of laser output of 3 Kw, and at a processing speed of 30 m/min. can be realized, and the processing quality can be improved at the same time.

FIG. 12 is a conceptual diagram which shows another example of the processing head 11 actually designed. In this processing head 11, a ring-shaped electrode 18 for detecting capacitance is provided to a support member 25 formed of an insulating material. Since the processing nozzle 13 is formed of a conductor, the end portion functions as the electrode for adsorption 17. Also in the processing head 11 constituted as described above, if a predetermined voltage is applied to between the processing nozzle 13 and the workpiece 15, the laser processing apparatus shown in FIG. 1 can be realized. Further, since the electrode 18 for detecting capacitance has only to be provided in a ring form on the outer peripheral portion of the processing nozzle 13, not only the structure becomes simple, but also application to the existing processing head 11 becomes quite easy.

As described above, according to this invention, the plasma generated due to the irradiation of the laser beam is adsorbed by the electrode for adsorption and the workpiece, and hence such a situation that the plasma fills the space between the electrode for detecting capacitance and the workpiece can be effectively prevented. As a result, it becomes possible to accurately control the focal position of the laser beam, based on the capacitance between the electrode for detecting capacitance and the workpiece, and even when the plasma is generated, laser processing with excellent processing quality can be performed.

According to the next invention, since the processing nozzle functions as the electrode for adsorption, the electrode for adsorption can be easily formed.

According to the next invention, sufficient distance can be ensured between the laser processing position and the electrode for detecting capacitance. As a result, the adsorption efficiency of the plasma can be improved, and the plasma which cannot be adsorbed die out spontaneously, thereby the above-described working effect becomes more noticeable.

According to the next invention, since the laser processing conditions can be controlled depending on the quantity of plasma generated by the laser processing, it becomes possible to perform laser processing with excellent processing quality.

According to the next invention, since the current value flowing between the electrode for detecting current and the workpiece is detected as the plasma quantity, the plasma quantity can be detected easily and accurately.

According to the next invention, when the current value exceeds a first threshold, a processing malfunction detection signal is output. As a result, the processing malfunction can be detected.

According to the next invention, when the processing malfunction detection signal is output from the malfunction detection signal output unit, the processing speed is decreased and/or the laser output is increased. As a result, the processing malfunction can be restored to the normal state automatically.

According to the next invention, when the processing nozzle touches the workpiece, the contact detection signal is output. As a result, it is possible to detect that the processing nozzle has touched the workpiece.

According to the next invention, processing speed and/or the laser output is controlled so that the value of the current flowing between the electrode for detecting the current and the workpiece always falls below the upper tolerance, in other words, so that the generation of plasma falls below the upper tolerance. As a result, it becomes possible to perform laser processing with excellent processing quality.

According to the next invention, the position of the processing nozzle is controlled with respect to the workpiece, so that the current value becomes minimum, that is, the plasma quantity becomes minimum. As a result, it becomes possible to perform laser processing with excellent processing quality.

### INDUSTRIAL APPLICABILITY

As described above, according to the laser processing apparatus of the present invention, it is suitable for the application in which laser processing with excellent processing quality is to be performed.

1. A laser processing apparatus which processes a workpiece using a laser beam, comprising:
an electrode for adsorption arranged in the vicinity of a point at which the processing is performed; and
an electrode for detecting capacitance around the electrode for adsorption, wherein
voltage is applied to the electrode for adsorption and the workpiece and capacitance between the electrode for detecting capacitance and the workpiece is detected, and a focal position of the laser beam is controlled based on the detected capacitance.

2. The laser processing apparatus according to claim 1, wherein a processing nozzle which emits the laser beam is formed of an electrically conducting material, and a tip of the processing nozzle made to function as the electrode for adsorption.

3. The laser processing apparatus according to claim 1, wherein the portion of the electrode for adsorption which faces the workpiece is made flat, and the outer diameter of this flat portion is set such that at least 5-milimiter is ensured from the center thereof.

4. A laser processing apparatus which processes a workpiece using a laser beam, wherein
an amount of plasma generated at the time of the laser processing is detected, and laser processing conditions are controlled based on the detected amount of plasma.

5. The laser processing apparatus according to claim 4, further comprising: an electrode for detecting current provided at the end of the processing nozzle which emits the laser beam, and a detection unit which detects a value of a current flowing between the electrode for detecting current and the workpiece as the amount of plasma.

6. The laser processing apparatus according to claim 5, further comprising a malfunction detection signal output unit which outputs a processing malfunction detection signal, when the current exceeds a preset first threshold.

7. The laser processing apparatus according to claim 6, wherein when the processing malfunction detection signal is output from the malfunction detection signal output unit, any one or both of decreasing a processing speed and increasing a laser output is conducted.

8. The laser processing apparatus according to claim 5, further comprising a contact detection signal output unit which outputs a contact detection signal indicating that the processing nozzle has touched the workpiece, when the current reaches a value at the time when the processing nozzle and the workpiece are short-circuited.

9. The laser processing apparatus according to claim 5, wherein any one or both of a processing speed and a laser output are controlled so that the current is maintained lower than a preset tolerance value.

10. The laser processing apparatus according to claim 5, wherein the position of the processing nozzle is controlled with respect to the workpiece so that the current becomes minimum.
